(19) United States
(12) Patent Application Publication
(10) Pub. No.: US 2014/0067617 A1
(43) Pub. Date: Mar. 6, 2014

(54) System and Method for Ordering Items at a Work Site

(71) Applicants: Christian P. Heine, Arlington Heights, IL (US); Mahendra P. Srivastava, Duluth, GA (US); James D. Bohn, Bristol, WI (US); Teresa Celmer, Bartlett, IL (US)

(72) Inventors: Christian P. Heine, Arlington Heights, IL (US); Mahendra P. Srivastava, Duluth, GA (US); James D. Bohn, Bristol, WI (US); Teresa Celmer, Bartlett, IL (US)

(73) Assignees: SORTIMO INTERNATIONAL GMBH, Zusmarshausen (DE); ROBERT BOSCH TOOL CORPORATION, Broadview, IL (US)

(21) Appl. No.: 13/604,839

(22) Filed: Sep. 6, 2012

(51) Int. Cl. G06Q 30/06

(52) U.S. Cl. CPC G06Q 30/0635
USPC 705/26.81

(57) ABSTRACT

A system for ordering items includes a plurality of tagged containers, an item being stored in each container. A mobile electronic device reads data in a tag associated with one of the containers and identifies at least one supplier for the item that is within a predetermined distance of the mobile electronic device. The mobile electronic device sends an order request to a server that identifies the at least one type of item in the container and the at least one supplier. The server generates an order for the item with only the one supplier identified in the order request and sends the order to another server operated by the one supplier.

### TECHNICAL FIELD

This disclosure relates generally to item storage, inventory tracking, and inventory management systems, and, more specifically, to systems and methods for ordering items used at work sites.

### BACKGROUND

Professionals in a wide range of industries, including construction workers, plumbers, electricians, telecommunication service personnel, and HVAC service personnel often travel to work sites to participate in work projects. Since the work sites often lack the tools and supplies required to complete a project, the professionals often carry some or all of the necessary equipment in a vehicle, such as a van or work truck, to the work site. For example, a work truck often carries a wide range of tools from hammers and screwdrivers to power tools including drills, saws, belt sanders, nail drivers, and the like. Tools can include further components such as batteries, replaceable drill bits, saw blades, sanding pads, and the like that may require occasional replacement during a job. Additionally, the work truck often includes a wide range of consumables, such as nuts, bolts, washers, screws, nails, lumber, pipe, wire, and the like that typically remain on the work site as part of the finished project. Consumables can further include items such as water, sunscreen, stock for portable restrooms, and other products that are consumed at the work site.

Proper organization of tools and consumables in a work vehicle and on the work site enables professionals to operate more efficiently. For example, a properly organized tool system enables a professional to find an appropriate tool, such as a power screwdriver, an appropriate screwdriver bit for the power screwdriver, and the appropriate screws for a particular task. If any one of these items is misplaced or is difficult to find, then the professional wastes time searching for the correct components instead of performing the task at hand.

An example of an organizational system that enables efficient storage and access to tools and consumables is sold commercially as the Globelyst System from Sortimo International GmbH of Zusmarshausen, Germany. The Globelyst System includes a modular system of shelving and rails that holds a plurality of storage containers, which are sold commercially as L-Boxxes by Sortimo and by Robert Bosch GmBH of Stuttgart, Germany. The individual L-Boxxes lock together and engage shelves and rails in the Globelyst System to enable organization and storage of the L-Boxxes in a secure manner in the vehicle during transport. The L-Boxxes are optionally removable for convenient transport between the vehicle and the work site. The molded inserts in the L-Boxxes enable secure storage and organization of power tools within the L-Boxxes. Due to the modular design of the Globelyst System and L-Boxxes, the work vehicle can store a wide variety of different tool and consumable loads to accommodate the requirements of different projects. While the Globelyst System is described for illustrative purposes, various other organizational systems including one or more containers, shelves, and drawers are known to the art for storage and organization of tools and consumables at a work site.

While the existing storage containers can provide organization for storing and organizing tools and consumables, the management of tools and consumables often go beyond storage and organization. For example, when the supply of a consumable is low or exhausted, work at the work site can be interrupted until the consumable is resupplied. Additionally, if a component in a tool needs to be replaced or if a new tool is needed on the work site, the professional must travel off-site or place an order for delivery of the item. Since a work site often includes a large number of tools and consumables, the process of resupplying different items, often from multiple suppliers, consumes time that could otherwise be devoted to completing a project. Consequently, organizational systems for items used in a work site, including tools and consumables, that improve the process for resupplying items at a work site would be beneficial.

### SUMMARY

In one embodiment, a system for generating orders for an item has been developed. The system includes a plurality of containers, each container being configured to hold at least one type of item, a plurality of tags, each tag in the plurality of tags being affixed to one container in the plurality of containers, each tag being configured to store data corresponding to the at least one type of item stored in the one container in the plurality of containers, a mobile electronic device having a processor and memory, and a server communicatively coupled to the mobile electronic device. The mobile electronic device includes a software application program including instructions stored in the memory of the mobile electronic device and the processor executes the instructions stored in the memory of the mobile electronic device to receive from a sensor in the mobile electronic device data corresponding to the at least one type of item in one of the containers from one tag in the plurality of tags that is associated with the one container, generate location data of the mobile electronic device with a signal receiver in the mobile electronic device, identify a plurality of suppliers that supply the at least one type of item with reference to the data corresponding to the at least one type of item, identify one supplier from the identified plurality of suppliers that is within a predetermined distance of the mobile electronic device with reference to the location data, generate an order request for the at least one type of item, the order request including an identifier of the one identified supplier for the at least one type of item, and transmit the order request with a wireless network device in the mobile electronic device. The server includes a database that stores data corresponding to the plurality of suppliers for each type of item held in the plurality of containers. The server is configured to receive the order request generated by the mobile electronic device, generate an order for the at least one type of item from the one supplier identified in the order request, the order being generated by the server with reference to supplier data corresponding to the one supplier identified in the order request that are stored in the database, and send the order to another server operated by the one identified supplier.

In another embodiment, a system for generating orders for a tool component has been developed. The system includes a tag configured to be associated with a tool and to store data corresponding to a plurality of components associated with the tool, a mobile electronic device having a processor and memory, and a server communicatively coupled to the mobile electronic device. The mobile electronic device includes a software application program including instructions stored in the memory of the mobile electronic device and the processor executes the instructions stored in the memory of the mobile electronic device to receive, from a sensor in the mobile electronic device, data corresponding to the plurality of components from the tag; generate location data of the mobile electronic device with a signal receiver in the mobile electronic device, identify a plurality of suppliers that supply the plurality of components, identify one supplier from the identified plurality of suppliers that is within a predetermined distance of the mobile electronic device with reference to the location data, generate an order request for at least one component in the plurality of components, the order request including an identifier of the one identified supplier for the at least one component, and transmit the order request with a wireless network device in the mobile electronic device. The server includes a database that stores data corresponding to the plurality of suppliers for each of the plurality of components. The server is configured to receive the order request generated by the mobile electronic device, generate an order for the at least one component in the order request from the one supplier identified in the order request, the order being generated by the server with reference to supplier data corresponding to the one supplier identified in the order request that are stored in the database, and send the order to another server operated by the one identified supplier.

In another embodiment, a method of ordering an item has been developed. The method includes receiving, with a sensor in a mobile electronic device, data corresponding to at least one type of item in one container from a tag that is associated with the one container, generating, with a signal receiver in the mobile electronic device, location data of the mobile electronic device, identifying, with a processor in the mobile electronic device, a plurality of suppliers that supply the at least one type of item with reference to the data corresponding to the at least one type of item, identifying, with the processor in the mobile electronic device, one supplier from the identified plurality of suppliers that is within a predetermined distance of the mobile electronic device with reference to the location data, generating, with the processor in the mobile electronic device, an order request for the at least one type of item, the order request including an identifier of the one identified supplier for the at least one type of item, transmitting, with a wireless network device in the mobile electronic device, the order request to a server, generating, with the server, an order for the at least one type of item from the one supplier identified in the order request, the order being generated with reference to supplier data corresponding to the one supplier identified in the order request, and sending the order from the server to another server operated by the one identified supplier.

### BRIEF DESCRIPTION OF THE DRAWINGS

FIG. 1 is a schematic diagram of an inventory management and resupply system for consumables, tools, and tool components, including attachments and accessories for a tool.

FIG. 2 is a perspective view of a plurality of containers that are configured to store different consumables and that include tags storing data about the consumables.

FIG. 3A is a perspective view of a container that is configured to store three different consumables and a single radio frequency tag that stores data about each of the three consumables.

FIG. 3B is a perspective view of a container that is configured to store three different consumables and a single two-dimensional barcode tag that stores data about each of the three consumables.

FIG. 4 is a schematic diagram of components in a mobile electronic device that is configured to operate with the system depicted in FIG. 1.

FIG. 5 is a block diagram of a process for ordering consumables using data stored in tags that are associated with containers that hold the consumables.

FIG. 6 is a perspective view of a tool with a tag affixed to the tool.

FIG. 7 is a schematic diagram depicting sections of a memory in the tag affixed to the tool in FIG. 6.

FIG. 8 is a block diagram of a process for ordering tools and components for tools using data stored in tags that are associated with the tools.

### DETAILED DESCRIPTION

For the purposes of promoting an understanding of the principles of the embodiments described herein, reference is now made to the drawings and descriptions in the following written specification. No limitation to the scope of the subject matter is intended by these references. This patent also encompasses any alterations and modifications to the illustrated embodiments as well as further applications of the principles of the described embodiments as would normally occur to one skilled in the art to which this document pertains.

As used herein, the term “mobile electronic device” refers to any electronic device that is configured to read tags associated with a container or a tool for generation of order requests that are sent via a wireless communication network to an inventory management server. Examples of mobile electronic devices include, but are not limited to, smartphones, tablets, notebook computers, and the like. Another example of a mobile electronic device is a wearable computing device, such as a computing device that is integrated with a pair of glasses or other articles of clothing. The wearable computing device includes one or more sensors that read and optionally write data to tags. Still another example of a mobile electronic device is an in-vehicle computing system that displays information retrieved from tags. In some configurations, the in-vehicle computing system includes one or more tag sensors in the vehicle to read and optionally write data to tags, while other configurations include a display, such as a dashboard display, to enable a user to view tag data retrieved using another mobile electronic device such as a smartphone. The mobile electronic devices use a combination of hardware and software to generate order requests.

As used herein, the term “tag” refers to any device or article that is affixed to a container or tool to store data about items held in the container or about the tool. The tag stores data in a format that is readable by one or more mobile electronic devices. One example of a tag is a printed one or two-dimensional barcode encoded in any of a number of standardized formats for storing data. A camera or other optical device in a mobile electronic device scans or reads the two-dimensional barcodes to read data encoded in the barcode. Another type of tag includes a radio transponder with an integrated memory. Examples of radio transponder tags include radio frequency ID (RFID) and near field communication (NFC) tags. The radio transponder tags can store data that are read by a radio scanner or a reader in the mobile electronic device. Some forms of radio transponder tags include a writeable memory that stores data transmitted from the radio scanner or the reader in the mobile electronic device during a data write operation in addition to providing stored data to the mobile electronic device during a data read operation.

NFC tags operate using a short-range wireless communication signal, typically over a distance of several centimeters between a tag reader and a passive NFC tag that does not include a battery or independent power source. Active NFC tags include a battery or other independent power source and can communicate over longer distances. Typical NFC tags and tag sensors operate, for example, at 13.56 MHz with an over-the-air communication interface defined by the ISO/IEC 18000-3 standard. Typical NFC data transmission rates ranging from, for example, 106 kbit/s to 424 kbit/s. In general, NFC tags operate at lower radio frequencies than other forms of passive RFID that typically operate in the hundreds of megahertz or gigahertz frequency bands.

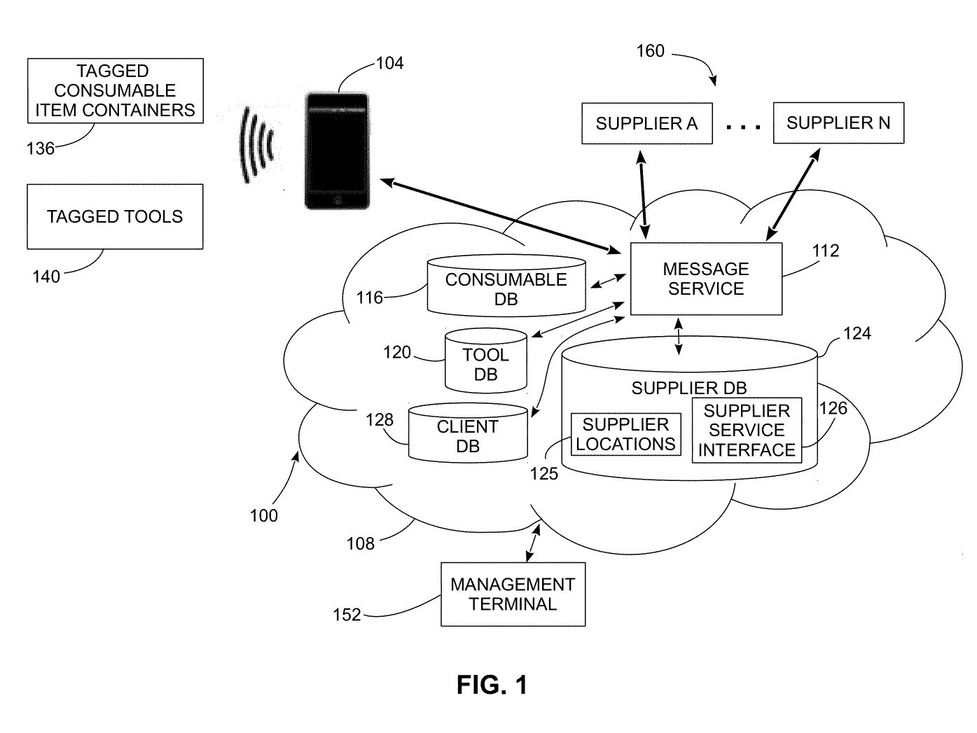

FIG. 1 depicts an inventory management system 100 that enables resupply of consumables, tools, and components for tools with a mobile electronic device in conjunction with tags associated with the consumables, tools, and components. The system 100 includes at least one mobile electronic device 104, an inventory management server 108, an optional management terminal 152, a plurality of tagged containers holding items 136, and one or more tagged tools 140.

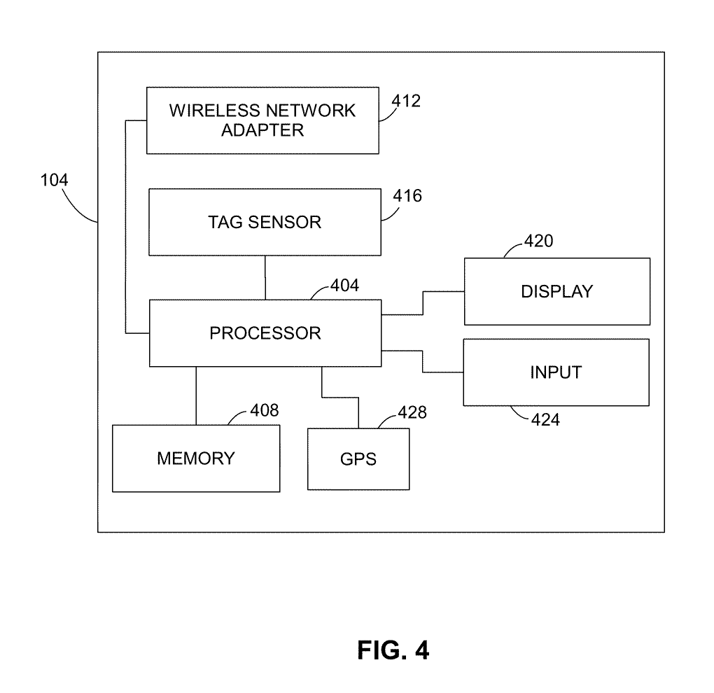

FIG. 4 depicts the mobile electronic device 104 in more detail. The mobile electronic device 104 includes a processor 404, memory 408, wireless network adapter 412, tag sensor 416, a display device 420, input device 424, and an optional global positioning system (GPS) receiver 428. The processor 404 includes one or more central processing units (CPU), graphical processing units (GPU), digital signal processors (DSP), field programmable gate arrays (FPGA) and application specific integrated circuit (ASIC) devices. The processor 404 reads and writes data from the memory 408. The memory 408 includes a non-volatile data storage device, such as solid state data storage, for long-term storage of data and instructions for software application programs, which include operating system software and software application programs that read tags and generate order requests in the system 100. In some embodiments, the memory 408 includes volatile data storage devices, such as static or dynamic random access memory (RAM), for short-term data storage during operation. In the mobile electronic device 104, the processor 404 and other components including the memory 408, wireless network adapter 412, tag sensor 416, and GPS receiver 428 can be integrated into a single device in a system on a chip (SoC) configuration.

In the mobile electronic device 104, the processor 404 is operatively connected to the tag sensor 416. In one configuration, the tag sensor 416 includes a digital camera or other optical sensor that is configured to generate image data corresponding to bar codes and other visible indicia on a tag. The processor 404 extracts information that is encoded in the image data to “read” the tag. A light source, such as a laser or LED light, is incorporated in the mobile electronic device 104 and activated to illuminate the tag and improve the reliability of reading the tag under low light conditions.

In another configuration, the tag sensor 416 is a radio transceiver that activates a radio transponder in a tag when the tag sensor 416 is held in close proximity to the tag. The tag sensor 416 radiates a small amount of energy to provide power to the tag inductively through an antenna coil connected to the radio transponder in the tag, although some tag embodiments include an independent power source. The tag sensor 416 includes a radio transceiver that receives data stored in the tag. In some configurations, the radio transceiver in the tag sensor 416 sends data to the radio transponder in the tag as part of a query for information stored in the tag or to store new data in the tag memory. Some mobile electronic devices include both cameras and radio transponder readers to enable interaction with multiple tag types.

In the mobile electronic device 104, the wireless network adapter 412 is operatively connected to the processor 404 and includes a combination of hardware and/or software modules to enable communication using one or more wireless data networks, which can include wireless wide area networks (WWAN) and wireless local area networks (WLAN). The wireless network adapter 412 enables the mobile electronic device 104 to communicate with the inventory management server 108 in the system 100. For example, the wireless network adapter 412 sends requests for geographic data and order requests to the inventory management server 108, and receives order confirmation messages from the inventory management server 108.

The mobile electronic device 104 includes a display 420 and input device 424 to enable interaction with an operator in possession of the mobile electronic device 104. The display 420 typically includes a liquid crystal display (LCD) or organic light emitting diode (OLED) output panel that displays graphics, text, and other visible indicia associated with data read from tags and with order requests for consumables, tools, and tool components such as attachments and accessories used with different types of tools. The input devices 424 include, but are not limited to, touch screen inputs, virtual and physical keyboards, mice, speech input and recognition systems, and the like. During operation of the mobile electronic device 104, the display 420 and input devices 424 enable operators to modify and review order requests in the inventory management system 100 and to view order confirmation messages.

In the mobile electronic device 104, the optional GPS receiver 428 generates geolocation data for the mobile electronic device 104 using the Global Positioning System or an equivalent such as Galileo or GLONASS. The GPS receiver 428 generates the geolocation data with a high degree of precision. In conjunction with mapping software programs or online services, the processor 404 can automatically identify an estimated street address of the mobile electronic device 104 for identifying the relative distance from a work site to multiple suppliers and placing orders without requiring manual input of the delivery address. In embodiments that omit the GPS receiver 428 or in situations where the GPS receiver 428 is inoperable, the mobile electronic device 104 receives geolocation data using with the wireless network adapter 412 using, for example, network location services or triangulation. The geolocation data received with the wireless network adapter 412 often has less precision than the data from the GPS 428, but the precision of the geolocation data is sufficient to enable identification of a relative distance between the mobile electronic device 104 and multiple suppliers.

Referring again to FIG. 1, the inventory management server 108 includes hardware and software to implement a message service 112, consumable database (DB) 116, tool DB 120, supplier DB 124, and client DB 128. In FIG. 1, the server 108 includes multiple hardware computing devices in a clustered configuration to provide scalability and fault tolerance, but a single computing device implements the functionality of the server 108 in another embodiment. The databases and services implemented in the inventory management server 108 and the operation of the remove inventory server 108 are described in more detail below.

In the inventory management server 108, the message service 112 is communicatively coupled to both the mobile electronic device 104 and to one or more suppliers 160 through a data network, such as the Internet. The message service 112 receives order request messages from the mobile electronic device 104 that include identifying information for consumables, tools, or tool components, and optionally a list of approved suppliers for the order. The message service 112 sends confirmation messages to the mobile electronic device 104 indicating the success or failure of an order request. The mobile electronic device 104 also sends supplier location queries to the message service 112 and the message service 112 returns suppliers that are located within a predetermined distance of the mobile electronic device. The message service 112 also generates orders and sends order messages to a plurality of suppliers 160 in response to receiving order request messages from the mobile electronic device 104.

The consumable DB 116 includes one or more tables or other appropriate data structures that map between identification data associated with a consumable item and identifiers for the consumable item that correspond with one or more suppliers. For example, when the message service 112 receives an order request message, the order request includes identifier data corresponding to one or more consumable items in the consumable DB 116. The consumable DB 116 includes identifiers for each consumable item that are compatible with at least one of the suppliers 160. For example, a stainless steel quarter-inch bolt is identified in an order request with a first numeric identifier “1234.” The consumable DB identifies the bolt with the numeric identifier in the list and can identify that three different suppliers A, B, and C associate the bolt with a different stock-keeping unit (SKU) identifier for each of the respective suppliers. As described below, the message service 112 uses the SKU number or other identifier recognized by one of the suppliers when placing an order with the one supplier.

The tool DB 120 includes a similar arrangement of data as the consumable DB 116, including one or more tables or other appropriate data structures that map between identifiers for tools that are sent with order requests and identifiers for the tools that are recognized by the suppliers 160. For example, a handheld saw has a tool identifier in the tool DB 120 as a complete tool including all components that are sold with the tool commercially. Some or all of the tools in the tool database are further associated with replaceable components. Using the handheld saw as an example, the tool DB 120 also associates the handheld saw with replaceable components, such as saw blades and batteries. As described below, a tag incorporated with each tool stores identifiers for the tool components, including attachments for the tool and other accessories, such as batteries, and the tool DB associates the components with the tool and with identifiers for the components used by one or more of the suppliers 160.

The supplier DB 124 stores data corresponding to the multiple suppliers 160. The suppliers DB 124 includes one or more tables or appropriate data structures for identifying the supplier locations 125 and supplier interface data 126 that enables the message service 112 to communicate with online inventory and ordering systems for each of the suppliers 160. The supplier DB 124 also includes location data 125 corresponding to the suppliers 160. The location data include geolocation data (e.g. latitude/longitude of supplier locations) and/or street addresses of the suppliers 160. In terms of location data for a supplier, a single supplier can simply be a single store at a single location. Other suppliers, however, include multiple stores at multiple locations. For example, a large national hardware store chain stored in the supplier DB 124 can include hundreds or thousands of locations. For purposes of location identification, the individual locations of the hardware store chain are identified first by both the overall identity of the supplier and individually with each store location being a separate supplier.

In the server 108, the message service 112 sends geographic information in the supply database to the mobile electronic device 104 in response to a supplier location query. In one configuration, the query includes location data corresponding to the identified location of the mobile electronic device 104 and a request for supplier locations within a predetermined distance of the mobile electronic device. The query can further include a list of supplier identifiers to filter the results. For example, if Chain A and Chain B each have two locations within 15 miles of the mobile electronic device, but the query specifies that only Chain A locations should be returned to the mobile electronic device, then the message service 112 returns data from the supplier DB 124 for only the two Chain A locations. Additionally, the message service 112 omits a location of Chain A that is located 20 miles from the mobile electronic device from the query results that are returned to the mobile electronic device 104.

The supplier DB 124 also includes supplier service interface data 126 that are required for the message service 112 to generate item availability queries and orders with remote servers associated with the suppliers 160. For example, different suppliers typically implement different data services for checking the availability of consumables, tools, and tool components, and implement different services for placing orders. The services are often not completely compatible between the different vendors 160. The supplier DB 124 includes data, such as hypertext markup language (HTML) and extensible markup language (XML) templates, web service interface data, JavaScript application program interface (API) data, and any other data, required to interface with the inventory and ordering system for each of the vendors 160.

The client DB 128 includes tables or other appropriate data structures corresponding to the owner of the tagged containers 136 and tools 140. The client DB 128 stores payment information data, such as credit card information, associated with the client generating orders with the system 100. The client DB 128 also stores a history of order requests and a history of fulfilled orders, including the type of the ordered item, quantity, purchase price, and identifier of the supplier that fulfilled the order. The client DB 128 optionally stores order requests and proposed orders from a selected suppliers for approval by a manager. An external management terminal 152, such as a personal computer (PC), smartphone, or tablet, enables a manager to view data in the client DB and to approve orders for fulfillment with one of the suppliers 160. In the system 100, the server 108 implements a web server portal to enable the management terminal 152 to access the client DB 128 and other functionality of the server 108 using a web browser software program.

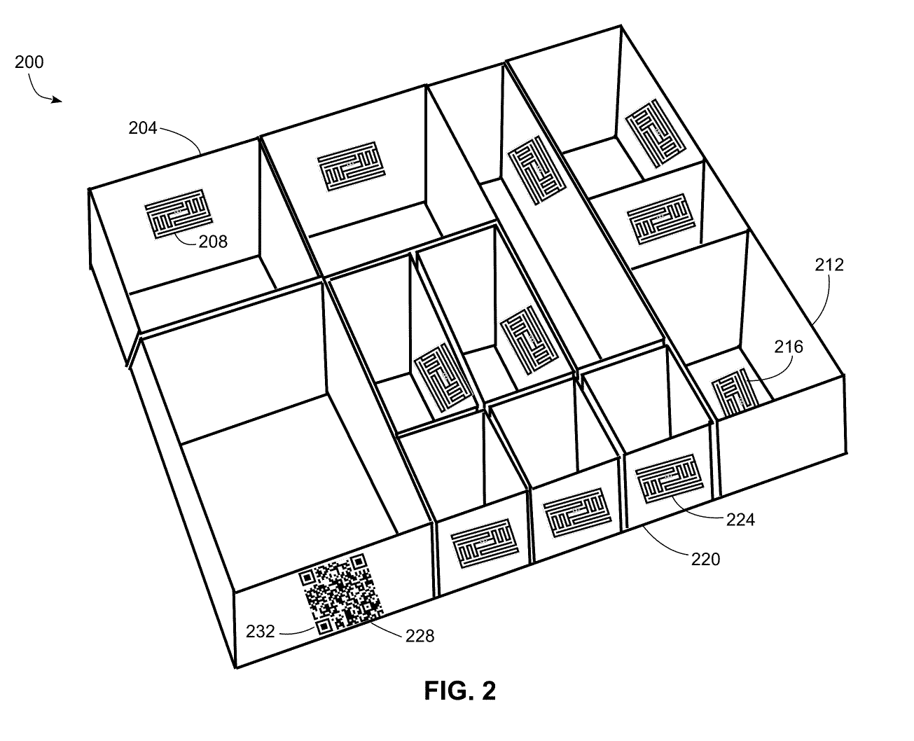

Referring to FIG. 2, consumable items in the system 100 are stored in a plurality of containers 136 that are associated with tags to enable the mobile electronic device 104 to identify the contents of each container in an automated manner. FIG. 2 depicts one example of a plurality of tagged containers 200. In FIG. 2, a set of individual containers 200 fit together into a rectangular arrangement. The containers 200 can be further stored in a larger container, such as a case, for convenient storage and transportation. Each container holds a quantity of a single consumable item such as, for examples, nuts, bolts, washers, nails, screws, and the like, although a wide range of items can be stored in each container. While the containers 200 are formed with rectangular shapes, other containers are formed with a variety of different geometries to store different items. Additionally, molded forms that engage tools or other items in place are incorporated into containers to store tools in a secure manner in the containers.

In FIG. 2, a tag is affixed to each of the containers 200. For example, a tag 208 is affixed to an inner surface of a wall in the container 204. In the embodiment of FIG. 2 the tag 208 is held in a sleeve or other mounting feature in the container 204 and can be replaced with another tag if the container 204 is repurposed to store a new item. In another configuration, the tag 208 is permanently affixed to the container 204 and the tag 208 is reprogrammed using, for example, the mobile electronic device 104 if the container 204 is repurposed to store a new item. The tag 208 is a radio transponder tag, such as an RFID or NFC tag, with a wire coil antenna that is electrically connected to a radio transponder and associated microelectronics, including a memory. In addition to storing data identifying the item stored in container 204, the tag 208 also includes identifiers for one or more suppliers that are approved for use when ordering the item held in the container 204.

In the plurality of containers 200, the tags are affixed to different locations in various individual containers. For example, a tag 216 is located on the floor of the container 212 and another tag 224 is located on an external wall of the container 220. Additionally, the containers 200 can include a plurality of tag types. For example, in addition to the radio transponder tags 208, 216, and 224, the container 228 bears a two-dimensional barcode 232 affixed to an exterior wall for convenient use with a camera or other optical sensor in the mobile electronic device 104. The tag 232 also stores data identifying the type of item stored in the container 228 and a list of one or more suppliers approved to resupply the item. The data stored in the barcode tag 232 are not directly reconfigurable. Instead, the barcode tag 232 is held in a sleeve or affixed to the container 228 with an adhesive backer, and a new printed tag can be affixed to the container 228 if a new consumable item is stored in the container 228.

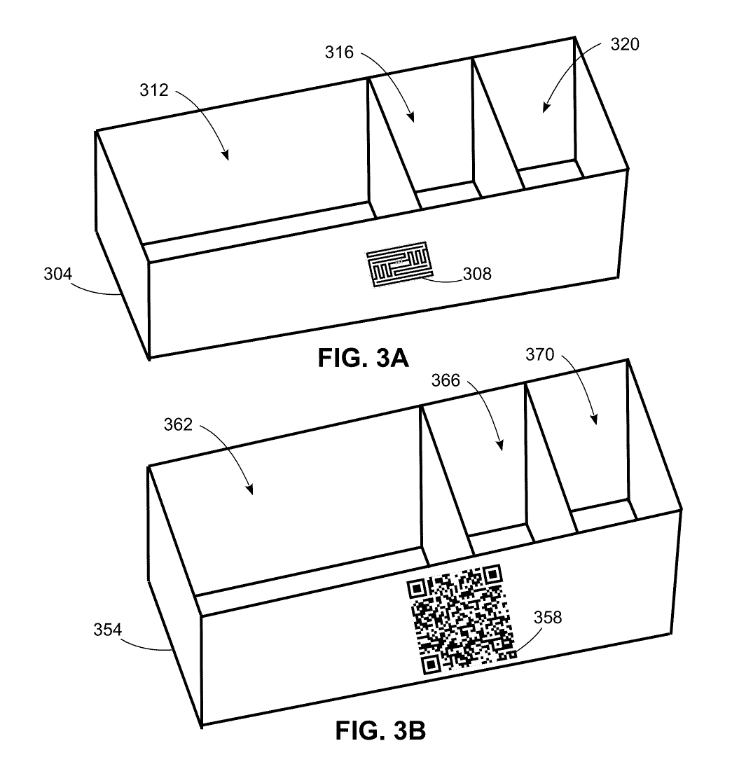

In FIG. 2, each container in the plurality of containers 200 stores a single type of consumable item. FIG. 3A and FIG. 3B depict containers 304 and 354, respectively, that store multiple types of items in sub-containers and include a single tag that stores data for the items in each of the sub-containers. In FIG. 3A, the container 304 includes three sub-containers 312, 316, and 320. Each sub-container stores a single type of consumable item, such as, for example, bolts in the container 312, washers in the container 316, and nuts in the container 320. A single tag 308 affixed to the container 304 stores data identifying each of the bolt, washer, and nut items in the container 304, and lists of suppliers for each item. In FIG. 3B, the container 354 is similarly configured with three sub-containers 362, 366, and 370 to hold three items. A two-dimensional barcode tag 358 stores the item and supplier identifiers for each of the three sub-containers. A single tag storing data for each of a plurality of sub-containers simplifies the generation of order requests to replenish each type of item when the items are typically used together and are replenished simultaneously. While FIG. 3A and FIG. 3B depict containers with rectangular shaped sub-containers, other containers are formed with a variety of different geometries to store different items.

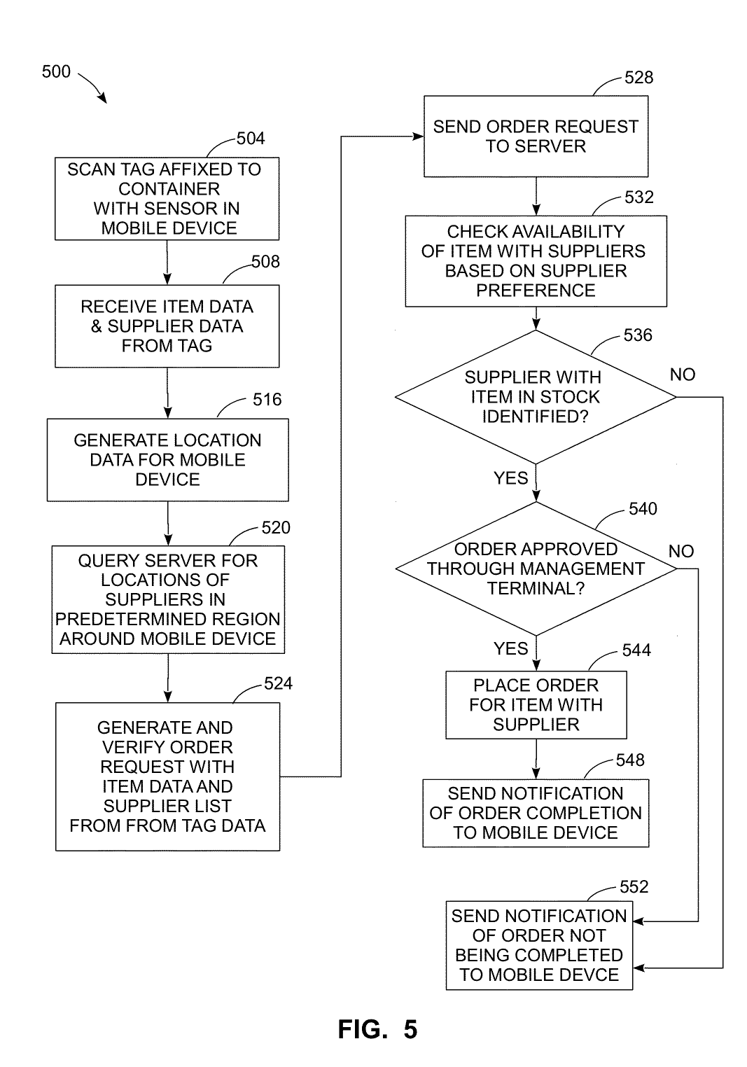

As described above, the inventory management system 100 enables the generation of orders for replenishment of consumables in the containers 136. FIG. 5 depicts a process 500 for generating orders for the consumables. Process 500 is described in conjunction with the system 100 for illustrative purposes. In the discussion below, a reference to the process 500 performing a function or action refers to one or more processors, such as the processor 404 and processors in the server 108, executing programmed instructions stored in a memory to perform the function or action.

In process 500, the mobile electronic device 104 reads a tag affixed to one of the containers 136 with the sensor 416 (block 504). As described above, the tags include radio-transponder tags and two-dimensional bar code tags, and an operator places the mobile electronic device in proximity to a tag in order to read the tag. The mobile electronic device 104 receives both identifier data corresponding to one or more consumable items in the container and data identifying one or more suppliers for the items (block 508). In one configuration, the owner of the containers 136 selects one or more suppliers for the consumable items stored in the containers 136 and identifiers for the suppliers are stored in the tags prior to moving the containers 136 to a work site. The operator of the mobile electronic device 104 is not necessarily the same party who stored the supplier data in the tags, and the mobile electronic device 104 does not need to store data corresponding to the suppliers prior to reading the tag.

Process 500 continues as the mobile electronic device 104 generates location data (block 516). As described above, the location data can include detailed geolocation data generated with the GPS receiver 428 or more general geolocation data generated with signals received from the wireless network adapter 412. The mobile electronic device 104 optionally identifies a street address using the geolocation data and a mapping software application program or online mapping service.

The mobile electronic device 104 queries the inventory management server 108 using the identified suppliers for the items in the container and the location data to retrieve a list of suppliers within a predetermined region of the mobile electronic device (block 520). In the system 100, the message service 112 in the server 108 receives the query and identifies suppliers in the supplier DB 124 that are specified in the query and that are within the predetermined region around the mobile device 104. In one configuration the predetermined region is a radius around the location of the mobile electronic device, while in another configuration the server 108 identifies the distance between the mobile electronic device and different suppliers with reference to the effective driving distance from the supplier using a mapping software application or online mapping service. The server 108 responds to the query from the mobile electronic device 104 with a list of suppliers and location data for the suppliers. In the embodiment of the system 100, the mobile device 104 caches store location query results in the memory 408 for a limited time after generating the query. Thus, if the mobile device 104 reads several tags successively for multiple orders that include a common set of suppliers, then the mobile device 104 identifies the locations of the stores in the memory 408 and does not need to repeat the processing described with reference to blocks 516 and 520.

Process 500 continues as the mobile electronic device 104 generates and verifies an order request that includes an identifier for at least one consumable item and at least one of the suppliers returned in the supplier query (block 524). In one configuration, the mobile electronic device 104 displays the order request on the display 420. An operator manually verifies that the order request is accurate, optionally adjusts a size of the order request from a default order size, and optionally enters a preference for one of the identified suppliers using the input device 424. When a large number of tags are arranged in a dense configuration, the verification process reduces or eliminates erroneous order requests. The mobile device 104 sends the order request to the message service 112 in the inventory management server 108 using the wireless network adapter 412 (block 528).

Once the inventory management server 108 receives the order request, the message service 112 checks the availability of the item or items identified in the order request with the suppliers listed in the order request in order of supplier preference (block 532). In the system 100, the message services 112 identifies consumable item SKUs for the individual suppliers 160 in the consumable DB 116 and generates item availability queries using supplier service interface data 126 from the supplier DB 124. As described in more detail below, if an order request includes multiple suppliers, then the message service 112 sends item availability queries to the multiple suppliers by order of supplier preference. In the process 500, the supplier with the highest preference that also has the identified consumable item or items available is selected to receive an order for the items.

In the processing described in block 532, the order of supplier preference refers to situations in which an order request specifies that multiple suppliers are authorized to fulfill an order for one or more identified consumable items. The suppliers can be ranked in order of preference using several techniques. In one technique, the suppliers are ranked in order of preference manually and the supplier data stored in the tag includes the ranking and preferences for the suppliers. In one configuration, the supplier data in the tag are arranged in an ordered list according to preference. The order request from the mobile electronic device includes the preference data for the selected suppliers. In another technique, the supplier preferences are assigned based on criteria, such as ranking the suppliers with reference to the distance of the supplier to the work site, or ranking suppliers with reference to the lowest identified price for the consumable items in the order request. The mobile electronic device 104 identifies some preference criteria, such as predetermined supplier preferences and location-based criteria, and includes the supplier preferences in the order request. The inventory management server 108 identifies other preference criteria, such as the order costs from multiple suppliers, and sets the preferences for the suppliers after receiving the order request.

In addition to identifying supplier preference with reference to predetermined preference order or criteria, the supplier preferences can be updated dynamically based on an order history. In the server 108, the client DB 128 stores a history of order requests and fulfilled orders for different consumable items stored in the containers 136. Process 500 generates rankings for the different suppliers based on the order history, and updates the rankings over time to account for changes in the order history.

In one order history preference configuration, process 500 generates a preference ranking for the suppliers in the order request with reference to the suppliers that most recently fulfilled an order for the item. For example, the client DB stores a history of order requests for different items and the supplier B was most recently used to fulfill an order for an item, while supplier A was used for an earlier order. The server 108 ranks the suppliers in descending preference order with supplier B followed by supplier A because supplier B most recently fulfilled the order. If in a subsequent order the supplier B does not have the item in stock and supplier A fulfills the order, then a subsequent ranking assigns a higher preference to supplier A.

In another order history preference configuration, process 500 generates a preference ranking for the suppliers in the order request with reference to the number of orders that each supplier has fulfilled in the past. For example, the client DB stores a history of order requests for different items and the supplier A has fulfilled the greatest number of orders for an item, while supplier B has been used for a smaller number of orders. The server 108 ranks the suppliers in descending preference order with supplier A followed by supplier B because supplier A has fulfilled the greatest number of orders. If in a subsequent order the supplier A does not have the item in stock and supplier B fulfills the order, then the number of orders fulfilled by the supplier B increases in the order history.

The ranking of suppliers with reference to the most recently used suppliers or to the number of orders fulfilled by each supplier can be general or specific to an item. In a general order history example, if supplier A fulfills the greatest number of orders a plurality of different item types or if supplier A has fulfilled the most recent order, then supplier A is assigned the highest preference without regard to the specific item or items in the order request. In an item-specific order history example, the suppliers are ranked based on the number of orders fulfilled for a particular item or the supplier that most recently supplied the particular item in the order request.

Referring again to FIG. 5, the message service 112 queries the availability of items in the order request with the suppliers 160 in the order of the preference ranking during the processing described with reference to block 532 until one supplier is identified with the available item in stock or all of the suppliers are queried and no supplier has the item in stock (block 536). If none of the suppliers have the item in stock, then the message service 112 sends a message to the mobile electronic device indicating that the order has not been completed (block 552). The message notifies the operator that the item is not in stock.

If an item is in stock with one of the suppliers in the order request (block 536), then process 500 optionally generates the order and holds the order until the management terminal 152 sends an approval message for the order (block 540). As described above, the management terminal 152 enables a manager, who is typically located at another location than the work site, to review and approve an order before the message service 112 sends the order to one of the suppliers 160. If the order is rejected, then the message service 112 sends a message to the mobile electronic device indicating that the order has not be fulfilled and optionally including an indicator that provides a reason for the rejection of the order (block 552). Some configurations of process 500 omit the approval process. Other configurations allow some orders without approval while requiring approval for other orders. For example, orders with a total price that is below a predetermined threshold proceed without requiring approval, while orders that exceed the price threshold require approval.

If the inventory management server 108 identifies a supplier for the item and the order is approved for processing, then the message service 112 places the order with the selected supplier (block 544). The message service 112 generates the order with item identifiers retrieved from the consumable DB 116 that are compatible with the ordering system of the identified supplier 160. The message service 112 generates the order in a suitable format for the selected supplier using data from the supplier service interface 126. For order types that also include a payment transaction, the message service 112 retrieves payment information from the client DB 128 to complete the payment transaction. Other types of order, such as orders for pickup from the supplier, are paid when the items are picked up from the supplier instead of being paid during the ordering process.

Process 500 continues with the message service 112 sending an order confirmation message to the mobile electronic device 104 (block 548). The order confirmation message includes information corresponding to the item ordered, location of the supplier that received the order, and any additional information required to ensure that the ordered item or items reach the work site. For example, the confirmation message in a delivery order includes tracking numbers for shipments and optionally has an estimated time of arrival for the shipment. Pickup orders are often retrieved using a vehicle at the work site, and the confirmation message includes the location of the supplier that received the order, optional navigation instructions to reach the supplier, and any required proof of purchase data such as receipts or order confirmation numbers.

As described above, the system 100 enables ordering of consumable items that are stored in tagged container of a wide variety of shapes and sizes. In addition to ordering consumables, the system 100 enables ordering of replacements for tools and components for tools using the mobile electronic device 104 and tags that are affixed to the tools or to containers storing the tools.

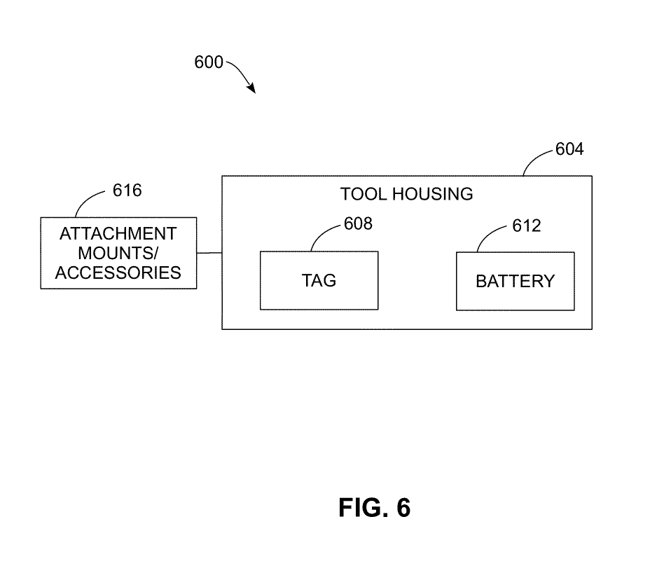

FIG. 6 is a schematic diagram of a tool 600 with a tool housing 604, a tag 608 affixed to the housing 604, a battery 612, and a mount 616 for tool components including attachments and other accessories. In different tool types, the tool components include batteries, such as the battery 612 in FIG. 6, and a wide range of attachments for tools including, but not limited to, drill and screwdriver bits, saw blades, sanding disks and belts, heads for socket wrenches, and the like. Additionally, a tool component includes accessories that are associated with the tool. For example, a belt holster for a handheld drill is one type of accessory associated with the drill. Other tool components include parts of the tool that are used for tool repair or maintenance, such as a replacement chuck for a drill, a new handle for a hammer, or lubricant for a power tool. In FIG. 6, the tag 608 is a radio-transponder tag, such as an NFC tag. The tag 608 includes a memory that includes both a read-only segment storing data that are programmed at the time of manufacture for the tool 600, and a read-write memory that the owner of the tool programs after the time of purchase. While the tag 608 is affixed to the tool housing 604 in the embodiment of FIG. 6, the tag 608 is affixed to a container that stores the tool 600 in another embodiment.

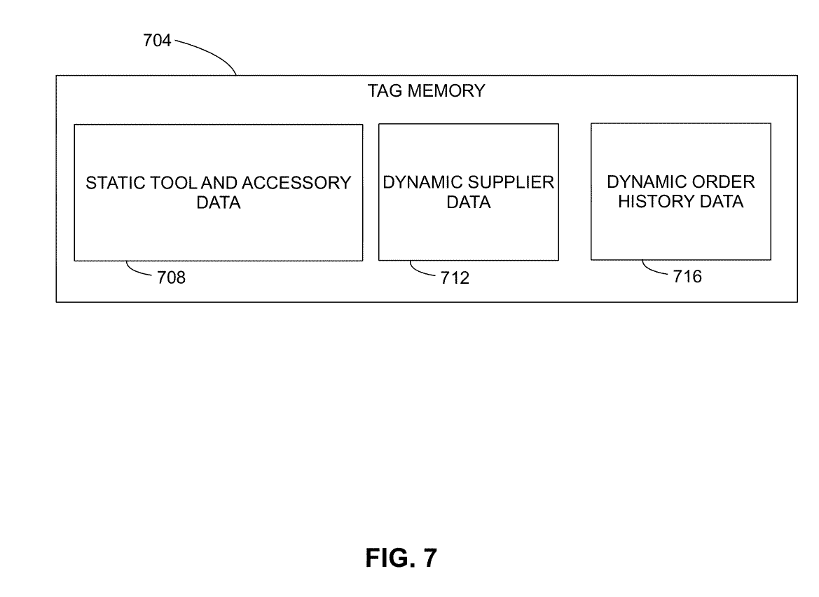

FIG. 7 depicts the memory 704 in the tag 608, which includes a static tool and accessory data segment 708, a dynamic supplier segment 712, and a dynamic order history segment 716. The static tool and accessory data in the memory segment 708 includes item identifiers for both the tool 604, and for components in the tool that can be ordered using the system 100. For example, the component data include item identifiers for the tool 604, the battery 612, and tool attachments that engage the chuck 616. In other types of tools, the tag stores component data corresponding to saw blades, replaceable drill and screw driver bits, sanding pads and belts, and any other suitable tool components. As described above, the static memory segment 708 is written once with the tool and component data.

The dynamic supplier segment 712 and order history segment 716 are reprogrammable memory segments that enable the mobile electronic device 104 or other suitable device to store data in the tag memory 704. The supplier memory segment 712 stores a list of suppliers that are approved for ordering the tool 604 or components for the tool 604. The history memory segment 716 stores item identifiers of components that have been ordered for the tool and the time at which the components were ordered. For example, when a new battery 612 is ordered for the tool 604, the mobile electronic device 104 stores the item identifier for the battery 612 and the date that the order was completed in the memory segment 716. As described below, the mobile electronic device 104 can store the order history data in response to receiving the order confirmation message from the inventory management server 108. The mobile electronic device 104 or another tag reading device can retrieve the history data at a later time to review when components for the tool were ordered for viewing and analysis. For example, the tool operator can retrieve the order date of a replacement battery from the memory segment 716 to determine if the battery is still under warranty.

While FIG. 7 depicts a single memory 704 with multiple segments, alternative configurations include a single memory that is rewritable to enable updates to both the tool and accessory data and the supplier and order history data. Other embodiments include a tag with a one-time writable memory where the tag is replaced with a new tag to update the contents of the memory. Still other embodiments include two tags where one tag stores only the static tool and accessory data while a second tag stores only dynamic supplier and order history data.

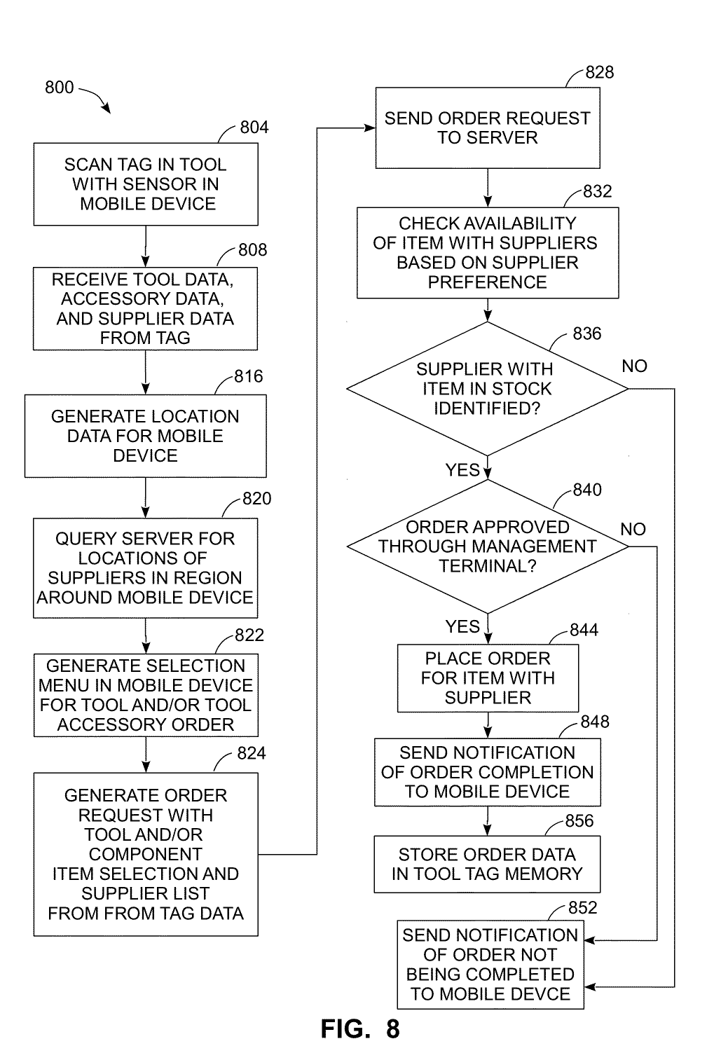

FIG. 8 depicts a process 800 for ordering a replacement for a tool or for components associated with the tool. Process 800 is described in conjunction with the system 100 for illustrative purposes. In the discussion below, a reference to the process 800 performing a function or action refers to one or more processors, such as the processor 404 and processors in the inventory management server 108, executing programmed instructions stored in a memory to perform the function or action. Process 800 includes several elements in common with the process 500 for ordering consumables that is described in FIG. 5 above, and the description of process 800 includes additional details of the process for ordering tools and tool components.

In process 800, the mobile electronic device 104 reads a tag affixed to a tool, such as the tag 608 affixed to the tool 604, or a tag corresponding to the tool that is affixed to a container for the tool with the sensor 416 (block 804). The mobile electronic device 104 receives data stored in the tag including the identifiers of the tool and to one or more components associated with the tool, and identifiers for suppliers that are stored in the tag (block 808).

Process 800 continues as the mobile electronic device 104 generates location data (block 816) and queries the inventory management server 108 for locations of suppliers in the region around the mobile electronic device (block 820). The processing of blocks 816 and 820 is performed in the same manner as described above with reference to the processing of blocks 516 and 520, respectively, in process 500.

During process 800, the mobile electronic device 104 retrieves multiple identifiers corresponding to the tool and components associated with the tool. The mobile electronic device subsequently generates a user interface to enable an operator to select one or more of the items for an order (block 822). In the mobile electronic device 104, the display 420 depicts a text list or graphical display identifying the tool and the individual components associated with the tool. The operator selects the tool and/or one or more tool components using the input device 424, and the mobile electronic device 104 generates the order request using the selected tool and/or components and the list of identified suppliers for the components (block 824).

Process 800 continues with the ordering process as depicted in blocks 828-852. The processing of blocks 828-852 is performed in the same manner as the processing described above with reference to blocks 528-552, respectively, in the process 500. In the event that the order request is fulfilled and the mobile electronic device 104 receives the order confirmation message (block 848), the mobile electronic device 104 updates the memory in the tool tag to maintain a record of the order (block 856). Using the tool 604 in FIG. 6 as an example, the mobile electronic device 104 stores the component identification data for each component in the order and a time stamp corresponding to the time when the order was placed. The update data are generated automatically from data in the order notification message, and the mobile electronic device 104 prompts the operator to place the tag sensor 416 in proximity to the tag 608 to store the data in the component history segment 716 of the tag memory 704.

The inventory management system 100 removes much of the complexity associated with placing orders for items, including consumables, tools, and tool components. While existing smartphones can be used to generate orders for an individual component using a web browser, the smartphone requires extensive manual input to complete an order for the item. Additionally, manually ordering components can be an error prone process for certain items like nuts, bolts, screws, and nails, which have numerous incompatible variants available from multiple vendors. The tags associated with each container ensure that an order request identifies the correct items in each order, and the inventory management server enables efficient location of an approved supplier for each item.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A system for generating orders for an item comprising:
a plurality of containers, each container being configured to hold at least one type of item;
a plurality of tags, each tag in the plurality of tags being affixed to one container in the plurality of containers, each tag being configured to store data corresponding to the at least one type of item stored in the one container in the plurality of containers;
a mobile electronic device having a processor and memory, a software application program including instructions stored in the memory of the mobile electronic device and the processor executes the instructions stored in the memory of the mobile electronic device to:
receive from a sensor in the mobile electronic device data corresponding to the at least one type of item in one of the containers from one tag in the plurality of tags that is associated with the one container;
generate location data of the mobile electronic device with a signal receiver in the mobile electronic device;
identify a plurality of suppliers that supply the at least one type of item with reference to the data corresponding to the at least one type of item;
identify one supplier from the identified plurality of suppliers that is within a predetermined distance of the mobile electronic device with reference to the location data;
generate an order request for the at least one type of item, the order request including an identifier of the one identified supplier for the at least one type of item; and
transmit the order request with a wireless network device in the mobile electronic device; and
a server communicatively coupled to the mobile electronic device, the server including a database that stores data corresponding to the plurality of suppliers for each type of item held in the plurality of containers, the server being configured to:
receive the order request generated by the mobile electronic device;
generate an order for the at least one type of item from the one supplier identified in the order request, the order being generated by the server with reference to supplier data corresponding to the one supplier identified in the order request that are stored in the database; and
send the order to another server operated by the one identified supplier.

2. The system of claim 1, the software application program including further instructions stored in the memory of the mobile electronic device that the processor executes to:
identify at least two suppliers in the plurality of suppliers that are within the predetermined distance of the mobile electronic device;
generate preference data including relative preferences of the at least two suppliers with reference to predetermined preference criteria; and
generate the order request for the at least one type of item including identifiers for each of the at least two suppliers and with the preference data in the order request.

3. The system of claim 2 the server being further configured to:
identify a plurality of suppliers from the at least two suppliers in the order request that have the at least one type of item available for order; and
identify the one supplier for the order from the plurality of suppliers that have the at least one type of item available for order, the one supplier having a highest preference in the preference data in the order request.

4. The system of claim 1 further comprising:
one container in the plurality of containers holding a first type of item in a first sub-container and a second type of item in a second sub-container;
a single tag affixed to the one container being configured to store data corresponding to the first type of item and the second type of item;
the software application program being further configured to:
receive from the sensor in the mobile electronic device data corresponding to the first type of item and the second type of item from the single tag in the plurality of tags; and
generate the order request for the first type of item and the second type of item, the order request including an identifier of one supplier for the first type of item and one supplier for the second type of item.

5. The system of claim 1, each tag in the plurality of tags further comprising:
a two-dimensional barcode.

6. The system of claim 1, each tag in the plurality of tags further comprising:
a memory configured to store the data corresponding to the at least one type of item; and
a radio transponder configured to transmit data in the memory of the tag to the sensor in the mobile electronic device.

7. The system of claim 6, the memory of the tag being further configured to:
store an identifier corresponding to the one supplier and transmit the identifier corresponding to the one supplier to the mobile electronic device.

8. A system for generating orders for tool components comprising:
a tag configured to be associated with a tool and to store data corresponding to a plurality of components associated with the tool;
a mobile electronic device having a processor and memory, a software application program including instructions stored in the memory of the mobile electronic device and the processor executes the instructions stored in the memory of the mobile electronic device to:
receive, from a sensor in the mobile electronic device, data corresponding to the plurality of components from the tag;
generate location data of the mobile electronic device with a signal receiver in the mobile electronic device;
identify a plurality of suppliers that supply the plurality of components;
identify one supplier from the identified plurality of suppliers that is within a predetermined distance of the mobile electronic device with reference to the location data;
generate an order request for at least one component in the plurality of components, the order request including an identifier of the one identified supplier for the at least one component; and
transmit the order request with a wireless network device in the mobile electronic device; and
a server communicatively coupled to the mobile electronic device, the server including a database that stores data corresponding to the plurality of suppliers for each of the plurality of components, the server being configured to:
receive the order request generated by the mobile electronic device;
generate an order for the at least one component in the order request from the one supplier identified in the order request, the order being generated by the server with reference to supplier data corresponding to the one supplier identified in the order request that are stored in the database; and
send the order to another server operated by the one identified supplier.

9. The system of claim 8, the software application program including further instructions stored in the memory of the mobile electronic device that the processor executes to:
identify at least two suppliers in the plurality of suppliers that are within the predetermined distance of the mobile electronic device;
generate preference data including relative preferences of the at least two suppliers with reference to predetermined preference criteria; and
generate the order request for the at least one component including identifiers for each of the at least two suppliers and with the preference data in the order request.

10. The system of claim 9 the server being further configured to:
identify a plurality of suppliers from the at least two suppliers in the order request that have the at least one component available for order; and
identify the one supplier for the order from the plurality of suppliers that have the at least one component available for order, the one supplier having a highest preference in the preference data in the order request.

11. The system of claim 8, the at least one component further comprising:
a battery.

12. The system of claim 8, the at least one component further comprising:
a replaceable bit.

13. The system of claim 8, the at least one component further comprising:
a saw blade.

14. The system of claim 8, the tag further comprising:
a memory configured to store the data corresponding to the at least one component; and
a radio transponder configured to transmit the data in the memory of the tag to the sensor in the mobile electronic device.

15. The system of claim 14, wherein the memory of the tag is configured to store an identifier corresponding to the one supplier and the radio transponder is configured to transmit the identifier corresponding to the one supplier to the mobile electronic device.

16. The system of claim 14, the server being further configured to:
send a confirmation message to the mobile electronic device in response to placing the order with the one supplier.

17. The system of claim 16, the software application program including further instructions stored in the memory of the mobile electronic device that the processor executes to:
identify a time at which the server places the order with reference to data in the confirmation message; and
transmit, with the sensor, data corresponding to the at least one component in the order request and the identified time at which the server placed the order to the tag for storage in the memory of the tag.

18. A method of ordering items comprising:
receiving, with a sensor in a mobile electronic device, data corresponding to at least one type of item in one container from a tag that is associated with the one container;
generating, with a signal receiver in the mobile electronic device, location data of the mobile electronic device;
identifying, with a processor in the mobile electronic device, a plurality of suppliers that supply the at least one type of item with reference to the data corresponding to the at least one type of item;
identifying, with the processor in the mobile electronic device, one supplier from the identified plurality of suppliers that is within a predetermined distance of the mobile electronic device with reference to the location data;
generating, with the processor in the mobile electronic device, an order request for the at least one type of item, the order request including an identifier of the one identified supplier for the at least one type of item;
transmitting, with a wireless network device in the mobile electronic device, the order request to a server;
generating, with the server, an order for the at least one type of item from the one supplier identified in the order request, the order being generated with reference to supplier data corresponding to the one supplier identified in the order request; and
sending the order from the server to another server operated by the one identified supplier.

19. The method of claim 18 further comprising:
identifying, with the processor in the mobile electronic device, at least two suppliers in the plurality of suppliers that are within the predetermined distance of the mobile electronic device;
generating, with the processor in the mobile electronic device, preference data including relative preferences of the at least two suppliers with reference to predetermined preference criteria; and
generating, with the processor in the mobile electronic device, the order request for the at least one type of item including identifiers for each of the at least two suppliers and with the preference data in the order request.

20. The method of claim 19, the predetermined preference criteria being preference data corresponding to the plurality of suppliers stored in the tag and received with the sensor in the mobile electronic device.

21. The method of claim 18 further comprising:
identifying, with the processor in the mobile electronic device, at least two suppliers in the plurality of suppliers that are within the predetermined distance of the mobile electronic device;
generating, with the processor in the mobile electronic device, the order request for the at least one type of item including identifiers for each of the at least two suppliers; and
generating, with the server, preference data including relative preferences of the at least two suppliers in the order request with reference to order history data;
identifying, with the server, a plurality of suppliers from the at least two suppliers in the order request that have the at least one type of item available for order; and
identifying, with the server, the one supplier for the order from the plurality of suppliers that have the at least one type of item available for order, the one supplier having a highest preference in the preference data in the order request.

22. The method of claim 21, the generation of the preference data further comprising:
identifying, with the server, a time at which each supplier in at least two suppliers most recently received an order for the at least one component with reference to the order history data; and
generating the preference data with a highest preference assigned to a supplier in the at least two suppliers having a most recent order time.

23. The method of claim 21, the generation of the preference data further comprising:
identifying, with the server, a number of orders generated for each supplier in at least two suppliers with reference to the order history data; and
generating the preference data with a highest preference assigned to a supplier in the at least two suppliers having a greatest number of orders.
